(19) United States
(12) Patent Application Publication
(10) Pub. No.: US 2026/0339613 A1
(43) Pub. Date: Oct. 29, 2026

(54) HIGH-RADIX MONTGOMERY MODULAR MULTIPLICATION CIRCUIT AND PARALLEL COMPUTATION METHOD THEREFOR

(71) Applicant: AMICRO TECHNOLOGY CO., LTD., Zhuhai (CN)

(72) Inventor: Zhan HU, Zhuhai (CN)

(73) Assignee: AMICRO TECHNOLOGY CO., LTD., Zhuhai (CN)

(21) Appl. No.: 19/708,726

(22) Filed: Jun. 15, 2026

Related U.S. Application Data
(63) Continuation of application No. PCT/CN2024/139210, filed on Dec. 13, 2024.

(30) Foreign Application Priority Data
Dec. 19, 2023 (CN) 202311746840.8

(51) Int. Cl. G06F 7/72

(52) U.S. Cl. CPC G06F 7/722

(57) ABSTRACT

A high-radix Montgomery modular multiplication circuit includes: a loop control module, including m groups of loop control units, and configured to execute loop computations in parallel to complete k+1 rounds of loop computations, cache intermediate data during the loop computations, read data for the loop computations from a storage module, and transmit corresponding data to a computation module; a core state machine module, configured to control starting and ending of each round of primary loop computation in the k+1 rounds of loop computations executed by the m groups of loop control units in the loop control module; the computation module, configured to receive data transmitted by the loop control module and perform a multiplication computation and an addition computation based on the received data; and the storage module, configured to store the data for the loop computations.

### CROSS-REFERENCE TO RELATED APPLICATIONS

This application is a continuation of International Application No. PCT/CN2024/139210, filed on Dec. 13, 2024, which claims priority to Chinese Patent Application No. 202311746840.8, filed on Dec. 19, 2023. The disclosures of the above-mentioned applications are hereby incorporated by reference in their entireties.

### TECHNICAL FIELD

The present disclosure relates to the field of modular multiplication circuit, in particular to a high-radix Montgomery modular multiplication circuit and a parallel computation method therefor.

### BACKROUND

A Montgomery modular multiplication algorithm is one of the widely-used methods for implementing a modular multiplication algorithm. As a basic unit of asymmetric encryption/decryption algorithms such as Rivest-Shamir-Adleman (RSA) and Elliptic Curve Cryptography (ECC), a computation speed of the Montgomery modular multiplication algorithm determines the overall computation efficiency of the algorithms. With the development and application of the information technology, the security of encryption/decryption algorithms has received increasing attention in order to improve the information security. At present, most encryption/decryption algorithms are implemented through hardware to avoid the occurrence of serious adverse effects in a case of the theft of encrypted/decrypted data due to software vulnerabilities. Currently, most modular multiplication circuits are designed based on the Montgomery algorithm and its variants. During the hardware implementation, a good balance between the circuit performance and a circuit area has not been achieved. There exists such a problem as a large circuit area when the circuit performance is improved, or poor circuit performance when the circuit area is small.

### SUMMARY

The present disclosure provides in some embodiments a high-radix Montgomery modular multiplication circuit, including: a loop control module, including m groups of loop control units, and configured to execute loop computations in parallel to complete k+1 rounds of loop computations, cache intermediate data during the loop computations, read data for the loop computations from a storage module, and transmit corresponding data to a computation module according to loop computation steps; a core state machine module, configured to control starting and ending of each round of primary loop computation in the k+1 rounds of loop computations executed by the m groups of loop control units in the loop control module; the computation module, configured to receive data transmitted by the loop control module and perform a multiplication computation and an addition computation based on the received data; and the storage module, configured to store the data for the loop computations for reading and invoking by the loop control module. The k+1 rounds of loop computations include in total k+1 rounds of primary loop computations, each round of primary loop computation in the k+1 rounds of primary loop computations includes a pre-start loop computation and k rounds of secondary loop computations, and at most m rounds of loop computations are executed by the loop control module in parallel, where k and m are positive integers, and k is an integral multiple of m.

The present disclosure further provides in some embodiments a parallel computation method for a high-radix Montgomery modular multiplication circuit, including: when an r^{th} group of loop control units completes a first round of secondary loop computation in a current round of primary loop computation, controlling, by a core state machine module, an (r+1)^{th} group of loop control units in an idle state to start executing a next round of primary loop computation. When r=m, the core state machine module controls a first group of loop control units to start executing the next round of primary loop computation when the r^{th} group of loop control units completes the first round of secondary loop computation in the current round of primary loop computation; when one group of loop control units starts executing one round of primary loop computation, the group of loop control units is switched from the idle state to an operating state, and when the group of loop control units completes one round of primary loop computation, the group of loop control units is switched from the operating state to the idle state.

According to the high-radix Montgomery modular multiplication circuit and the parallel computation method in the embodiments of the present disclosure, the plurality of groups of loop control units in the loop control module invokes the same storage module and performs a plurality of rounds of loop computations in parallel based on the same computation module, so as to maintain the high efficiency of the loop computations of the circuit while reducing a circuit area.

### BRIEF DESCRIPTION OF THE DRAWINGS

FIG. 1 is a schematic view showing a high-radix Montgomery modular multiplication circuit according to an embodiment of the present disclosure.

FIG. 2 is a schematic view showing a computation module according to an embodiment of the present disclosure.

FIG. 3 is another schematic view showing the computation module according to an embodiment of the present disclosure.

FIG. 4 is a schematic view showing a loop control unit according to an embodiment of the present disclosure.

FIG. 5 is a flowchart illustrating a parallel computation method for a high-radix Montgomery modular multiplication circuit according to an embodiment of the present disclosure.

FIG. 6 is a flowchart illustrating one round of primary loop computation executing by one group of loop control units according to an embodiment of the present disclosure.

FIG. 7 is a flowchart illustrating executing the pre-start loop computation to obtain the result of the pre-start loop computation according to an embodiment of the present disclosure.

### DETAILED DESCRIPTION OF THE EMBODIMENTS

The present disclosure will be described hereinafter in details in conjunction with the drawings. It should be appreciated that, the following specific embodiments are for illustrative purposes only, but shall not be used to limit the scope of the present disclosure.

Currently, most modular multiplication circuits are designed based on a Montgomery algorithm and its variants. During the hardware implementation, a good balance between the circuit performance and a circuit area has not been achieved. There exists such a problem as a large circuit area when the circuit performance is improved, or poor circuit performance when the circuit area is small. In order to improve the balance between the circuit area and the circuit performance of a high-radix Montgomery modular multiplication circuit, the present disclosure provides in some embodiments a high-radix Montgomery modular multiplication circuit in which a plurality of groups of loop control units in a loop control module invokes a same storage module and performs a plurality of rounds of loop computations in parallel based on a same computation module, so as to maintain the high efficiency of the loop computations of the circuit while reducing the circuit area.

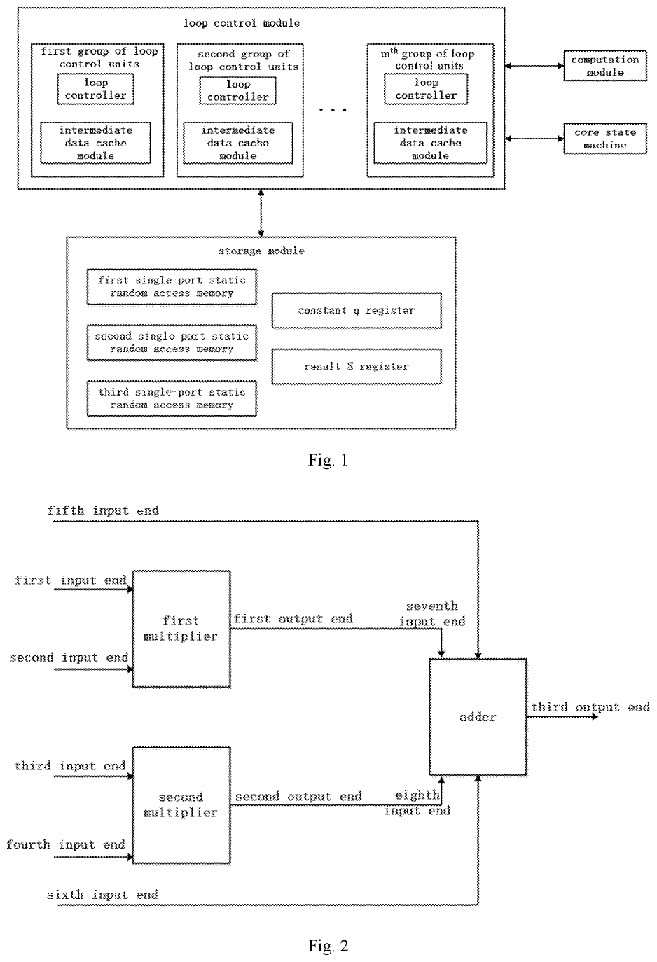

To be specific, as shown in FIG. 1, the high-radix Montgomery modular multiplication circuit includes: a loop control module, a core state machine module, a computation module, and a storage module.

The loop control module includes m groups of loop control units, and it is configured to execute loop computations in parallel to complete k+1 rounds of loop computations, cache intermediate data during the loop computations, read data for the loop computations from the storage module, and transmit corresponding data to the computation module according to loop computation steps. At most m rounds of loop computations are executed by the m groups of loop control units in the loop control module in parallel. The caching the intermediate data during the loop computations refers to transmitting, by the loop control unit, the corresponding data to the computation module according to the loop computation steps, and returning, by the computation module, data to the loop control unit according to a computation result. The intermediate data is used for the subsequent loop computation steps.

The core state machine module is configured to control starting and ending of each round of primary loop computation in the k+1 rounds of loop computations executed by the m groups of loop control units in the loop control module. To be specific, in order to enable the k+1 rounds of loop computations to be smoothly executed in parallel in the m groups of loop control units, the core state machine module controls a point at which each group of loop control units starts executing one round of loop computation. The controlling, by the core state machine module, the point at which a new round of loop computation starts to be executed includes, but not limited to, controlling a first group of loop control units to start executing the first round of loop computation after the high-radix Montgomery modular multiplication circuit is powered on, or controlling a next group of loop control units to start executing a next round of loop computation when a designated intermediate data computation is completed during the execution of one round of loop computation by a previous group of loop control units. The completion of the designated intermediate data computation includes, but not limited to, the completion of a first round of secondary loop computation in one round of primary loop computation.

The computation module is configured to receive data transmitted by the loop control module and perform a multiplication computation and an addition computation based on the received data. The computation module at least includes a multiplier and an adder for performing the multiplication computation and the addition computation respectively, and the quantity of multipliers and adders may be configured according to the practical computation need. The computation module is multiplexed by the loop control module in a time-division manner, so as to implement a complicated computation process through a simple computation module using a time-division multiplexing method, thereby to optimize the algorithm computation efficiency of the high-radix Montgomery modular multiplication circuit.

The storage module is configured to store the data for the loop computations for reading and invoking by the loop control module. The data in the storage module is invoked by the m groups of loop control units in the loop control module when the loop computations are executed in parallel, so as to reuse the data in a storage space, thereby to improve the utilization of the storage space, and reduce the circuit area while ensuring the circuit performance.

The high-radix Montgomery modular multiplication circuit in the embodiments of the present disclosure is used to implement a high-radix Montgomery modular multiplication algorithm. As a high-efficient modular multiplication algorithm, the high-radix Montgomery modular multiplication algorithm is used to perform modular multiplication without using division, and it is widely used in the field of cryptography. Here, k is equal to a radix of the high-radix Montgomery modular multiplication algorithm, so as to implement 2^{k}-bit modular multiplication. The k+1 rounds of loop computations include in total k+1 rounds of primary loop computations, each round of primary loop computation includes a pre-start loop computation and k rounds of secondary loop computations, where k and m are positive integers, and k is an integral multiple of m.

In an optional embodiment of the present disclosure, as shown in FIG. 1, the storage module includes three single-port static random access memories, one dual-port static random access memory, and two registers. The three single-port static random access memories include a first single-port static random access memory, a second single-port static random access memory, and a third single-port static random access memory.

The first single-port static random access memory is configured to store k+1 groups of multiplicands A, each group includes a 2^{k}-bit multiplicand A, lower k groups of multiplicands A are valid data, and a (k+1)^{th} group of multiplicand A is 0. A corresponding group of multiplicand A in the first single-port static random access memory is read and invoked by each group of loop control units when executing the pre-start loop computation and the secondary loop computations. A group index of the group of multiplicand A invoked by one group of loop control units from the first single-port static random access memory is determined based on a round index of one round of primary loop computations and a round index of one round of secondary loop computations which are executed by the group of loop control units. Preferably, the group of the loop control units invokes a group of multiplicand A from the first single-port static random access memory with a same group index as the round index of the round of the primary loop computation which is executed by the group of loop control units, e.g., when one group of loop control units executes a first round of primary loop computation, the group of loop control units invokes a first group of multiplicand A from the first single-port static random access memory for the first round of primary loop computation.

The second single-port static random access memory is configured to store k+1 groups of multipliers B, each group includes a 2^{k}-bit multiplier B, lower k groups of multipliers B are valid data, and a (k+1)^{th} group of multiplier B is 0. A corresponding group of multiplier B in the second single-port static random access memory is read and invoked by each group of loop control units when executing the pre-start loop computation and the secondary loop computations. When one group of loop control units invokes a group of multiplier B from the second single-port static random access memory for executing the pre-start loop computation, it invokes a first group of multiplier B, and a group index of one group of multiplier B invoked by one group of loop control units from the second single-port static random access memory for executing one round of secondary loop computation is determined based on a round index of the round of the secondary loop computation which is executed by the group of loop control units. Preferably, one group of loop control units invokes, from the second single-port static random access memory, one group of multiplier B with a group index equal to a round index of the round of the secondary loop computation which is executed by the group of loop control units plus 1, e.g., when one group of loop control units executes the first round of secondary loop computation, the group of loop control units invokes a second group of multiplier B from the second single-port static random access memory for the first round of secondary loop computation.

The third single-port static random access memory is configured to store k+1 groups of moduli N, each group includes a 2^{k}-bit modulus N, lower k groups of moduli N are valid data, and a (k+1)^{th} group of modulus N is 0. A corresponding group of modulus N in the third single-port static random access memory is read and invoked by each group of loop control units when executing the pre-start loop computation and the secondary loop computations. When one group of loop control units invokes one group of modulus N from the third single-port static random access memory for executing the pre-start loop computation, the group of loop control units invokes a first group of modulus N. When the group of loop control units invokes one group of modulus N from the third single-port static random access memory for executing one round of the secondary loop computation, a group index of the group of modulus N is determined based on a round index of the round of secondary loop computation which is executed by the group of loop control units. Preferably, the group of loop control units invokes, from the third single-port static random access memory, one group of modulus N with a group index equal to a round index of the round of secondary loop computation which is executed by the group of loop control units plus 1, e.g., when one group of loop control units executes the first round of secondary loop computation, the group of loop control units invokes a second group of modulus N from the third single-port static random access memory for the first round of secondary loop computation.

The dual-port static random access memory is configured to store k+1 groups of initial results S, and a result of each round of secondary loop computation. The k+1 groups of initial results S are used by one group of loop control units to execute the first round of primary loop computation. When the group of loop control units executes second to (k+1)^{th} rounds of primary loop computations, the group of loop control units uses a result of a previous round of secondary loop computation stored in the dual-port static random access memory.

The two registers include a constant q register and a result S register. The constant q register is configured to store a group of k-bit constants q, and the constant q is calculated through q=−N⁻¹ mod 2^{k}. The result S register is configured to store a result S(i) of each round of primary loop computation. In this embodiment of the present disclosure, the memory for storing the result S of each round of secondary loop computation is a dual-port static random access memory, so as to ensure that the memory storing the result S has a capability of performing both reading and storing computations in parallel. In this way, when a plurality of groups of loop control units in the loop control module operates in parallel, invoking computations for the initial result S and writing computations for the result of the secondary loop computation are performed simultaneously on the dual-port static random access memory.

In an optional embodiment of the present disclosure, as shown in FIG. 2, the computation module includes a first multiplier, a second multiplier and an adder. To be specific, the first multiplier includes a first input end, a second input end and a first output end; the second multiplier includes a third input end, a fourth input end and a second output end; the adder includes a fifth input end, a sixth input end, a seventh input end, an eighth input end and a third output end; the first input end, the second input end, the third input end, the fourth input end, the fifth input end and the sixth input end serve as input ports of the computation module and are coupled to the loop control module for receiving the data transmitted by the loop control module.

To be specific, the first output end of the first multiplier is coupled to the seventh input end of the adder, so as to transmit data obtained by the first multiplier to the adder. Usually, the data obtained by the first multiplier through multiplication is transmitted to the adder for addition. The second output end of the second multiplier is coupled to the eighth input end of the adder, so as to transmit data obtained by the second multiplier to the adder. Usually, the data obtained by the second multiplier through multiplication is transmitted to the adder for addition. The third output end of the adder serves as an output port of the computation module for outputting data obtained through addition. In the embodiments of the present disclosure, the computation module includes two multipliers and one adder, so that the two multipliers perform the multiplication computations in parallel.

Preferably, in some embodiments of the present disclosure, in order to improve the parallel computation capability, the high-radix Montgomery modular multiplication circuit is configured with a plurality of computation modules each including two multipliers and one adder, and the m groups of loop control units correspond to the plurality of computation modules, e.g., every 4 groups of loop control units correspond to one computation module including two multipliers and one adder, so as to improve the parallel computation efficiency of the groups of loop computations in the loop control module.

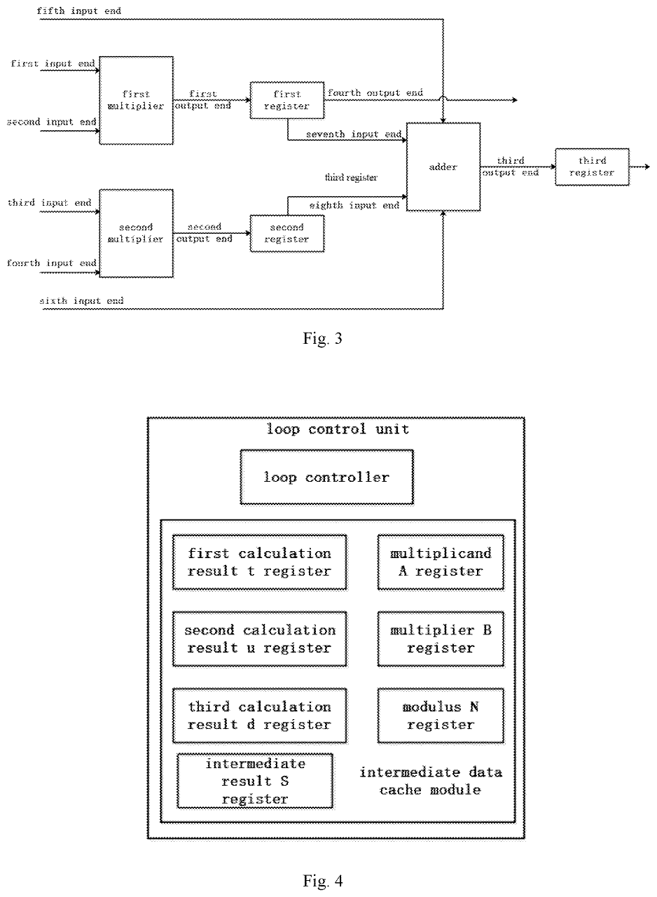

In an optional embodiment of the present disclosure, as shown in FIG. 3, the computation module further includes a first register, a second register and a third register. The first register is arranged between the first multiplier and the adder, the first output end is coupled to an input end of the first register, and an output end of the first register is coupled to the seventh input end of the adder. The second register is arranged between the second multiplier and the adder, the second output end is coupled to an input end of the second register, and an output end of the second register is coupled to the eighth input end of the adder. An input end of the third register is coupled to the third output end of the adder, and an output end of the third register serves as the output port of the computation module. In the embodiments of the present disclosure, through the first register between the first multiplier and the adder, the second register between the second multiplier and the adder and the third register between the adder and a loop computation device, it is able to interrupt the connection between the first/second multiplier and the adder, thereby to effectively improve the computation execution efficiency of the computation module.

In an optional embodiment of the present disclosure, as shown in FIG. 3, the first register further includes a fourth output end, and the fourth output end serves as the output port of the computation module for outputting the data obtained by the first multiplier through multiplication. In the embodiments of the present disclosure, with respect to a situation where the pre-start loop computation of the high-radix Montgomery modular multiplication algorithm does not include an addition computation, the first register is provided with the fourth output end to directly output the data obtained by the first multiplier through multiplication to the loop computation device outside the computation module without passing through the adder, so as to improve the feedback efficiency of intermediate computation results and reduce the unnecessary occupation of computation resources.

In an optional embodiment of the present disclosure, as shown in FIG. 4, each group of loop control units includes a loop controller configured to, in response to a start control signal for each round of primary loop computation from the core state machine module, read data stored in the storage module, and perform primary loop computation through multiplexing the first multiplier, the second multiplier and the adder in the computation module in a time-division manner according to the data read from the storage module, and further configured to control starting and ending of each round of secondary loop computation. To be specific, when the loop controller, in response to the start control signal for the primary loop computation from the core state machine module, controls the group of loop control units to execute a corresponding round of primary loop computation. The loop controller reads and invokes corresponding data from the storage module based on an execution progress of the primary loop computation, e.g., when executing the pre-start loop computation, it reads a group of result S(1) from the dual-port static random access memory, reads a group of multiplicand A(i) with a corresponding group index from the first single-port static random access memory based on a round index i of the round of primary loop computation executed by the group of loop control units, and reads a first group of multiplier B(1) from the second single-port static random access memory. The loop controller controls the starting and ending of each round of secondary loop computation based on the execution progress of the pre-start loop computation executed by the group of loop control units. When the execution of the pre-start loop computation is completed, the loop controller controls the starting of the first round of secondary loop computation. When a result of one round of secondary loop computation is obtained, the loop controller controls the ending of the round of secondary loop computation and the starting of a next round of secondary loop computation. When a result of a k^{th} round of secondary loop computation is obtained, the loop controller controls the ending of a k^{th} round of secondary loop computation. In the loop control units in this embodiment of the present disclosure, the data transmission between the loop control unit and each of the storage module, the core state machine and the computation module is controlled by the loop controller.

In an optional embodiment of the present disclosure, as shown in FIG. 4, each group of loop control units further includes an intermediate data cache module configured to cache data read from the storage module during the loop computations and computation intermediate data fed back by the computation module for reading and invoking by the loop controller. The intermediate data cache module includes a first calculation result t register, a second calculation result u register, a third calculation result d register, a multiplicand A register, a multiplier B register, a modulus N register, and an intermediate result S register.

The first calculation result t register is configured to cache a first calculation result t fed back by the computation module. The first calculation result t is obtained by the loop control unit in a first calculation step for executing one round of pre-start loop computation.

The second calculation result u register is configured to cache a second calculation result u fed back by the computation module. The second calculation result u is obtained by the loop control unit in a second calculation step for executing one round of pre-start loop computation.

The third calculation result d register is configured to cache a third calculation result d fed back by the computation module. The third calculation result d is obtained by the loop control unit in a third calculation step for executing one round of pre-start loop computation. The third calculation result d is used for k rounds of secondary loop computations in a same round of primary loop computations.

The multiplicand A register is configured to cache a multiplicand A read by the loop control unit from the first single-port static random access memory of the storage module. The multiplier B register is configured to cache a multiplier B read by the loop control unit from the second single-port static random access memory of the storage module. The modulus N register is configured to cache a modulus N read by the loop control unit from the third single-port static random access memory of the storage module. The intermediate result S register is configured to cache a result S read by the loop control unit from the dual-port static random access memory of the storage module. In this embodiment of the present disclosure, the intermediate data cache module is arranged in each group of loop control units, so as to, on one hand, cache the first calculation result t, the second calculation result u and the third calculation result d returned by the computation module for the invoking in a subsequent loop computation step, and on the other hand, invoke and cache the multiplicand A, the multiplier B, the modulus N and the result S from the storage module. In this way, it is able for the plurality of groups of loop control units operating in parallel to read and invoke data stored in the storage module, and improve the parallel computation efficiency of the m groups of loop control units through caching the data for the loop computations in the intermediate data cache module.

Preferably, the first calculation result t register, the second calculation result u register, the third calculation result d register, the multiplicand A register, the multiplier B register, the modulus N register and the intermediate result S register included in the intermediate data cache module are all registers capable of caching k-bit data. When new k-bit data is read and written, the new data is cached through overwriting old data.

In an optional embodiment of the present disclosure, in the high-radix Montgomery modular multiplication circuit, the first input end of the first multiplier is coupled to the multiplicand A register in each group of loop control units, to receive the multiplicand A cached in the multiplicand A register and transmitted by the group of loop control units. The first input end of the first multiplier is further coupled to the first calculation result t register in each group of loop control units, to receive the first calculation result t cached in the first calculation result t register and transmitted by the group of loop control units. The second input end of the first multiplier is coupled to the multiplier B register in each group of loop control units, to receive the multiplier B cached in the multiplier B register and transmitted by the group of loop control units.

The third input end of the second multiplier is coupled to the second calculation result u register in each group of loop control units, to receive the second calculation result u cached in the second calculation result u register and transmitted by the group of loop control units. The fourth input end of the second multiplier is coupled to the modulus N register in each group of loop control units, to receive the modulus N cached in the modulus N register and transmitted by the group of loop control units.

The fifth input end of the adder is coupled to the intermediate result S register in each group of loop control units, to receive the result S cached in the intermediate result S register and transmitted by the group of loop control units. The sixth input end of the adder is coupled to the third calculation result d register in each group of loop control units, to receive the third calculation result d cached in the third calculation result d register and transmitted by the group of loop control units. In this embodiment of the present disclosure, the input ends of the first multiplier, the second multiplier and the adder are coupled to the corresponding registers in the group of loop control units, so that the first multiplier is only used to perform a multiplication computation on the multiplicand A and the multiplier B and a multiplication computation on the first calculation result t and the constant q, and the second multiplier is only used to perform a multiplication computation on the second calculation result u and the modulus N. In this way, it is able to differentiate the multiplication computation step of the first multiplier from the multiplication computation step of the second multiplier in the loop computations, thereby to prevent the occurrence of confusion in the execution of the first multiplier and the second multiplier due to the parallel computation of the plurality of groups of loop control units.

The present disclosure further provides in some embodiments a parallel computation method for a high-radix Montgomery modular multiplication circuit, which includes: when an r^{th} group of loop control units completes a first round of secondary loop computation in a current round of primary loop computation, controlling, by a core state machine module, an (r+1)^{th} group of loop control units in an idle state to start executing a next round of primary loop computation. When r=m, the core state machine module controls a first group of loop control units to start executing the next round of primary loop computation when the r^{th} group of loop control units completes the first round of secondary loop computation in the current round of primary loop computation.

To be specific, when one group of loop control units starts executing one round of primary loop computation, the group of loop control units is switched from the idle state to an operating state, and correspondingly, when the group of loop control units completes one round of primary loop computation, the group of loop control units is switched from the operating state to the idle state.

When the pre-start loop computation in the current round of primary loop computation is executed to obtain the third calculation result d, a result of the first round of secondary loop computation in the previous round of primary loop computation needs to be used, and results of second to k^{th} rounds of secondary loop computations in the previous round of primary loop computation need to be used in the rounds of secondary loop computations, so in this embodiment of the present disclosure, the completion of the first round of secondary loop computation in the current round of primary loop computation is taken as a point for triggering the execution of the next round of primary loop computation.

When the next round of primary loop computation starts to be executed, at least the data for the computation step of calculating the third calculation result d in the pre-start loop computation is already available. In this way, it is able to improve the parallel computation efficiency while ensuring the smooth execution of one round of loop computation.

In an optional embodiment of the present disclosure, the logic for controlling, by the core state machine module, one group of loop control units to execute one round of primary loop computation is based on whether the first round of secondary loop computation in a previous round of primary loop computation is completed.

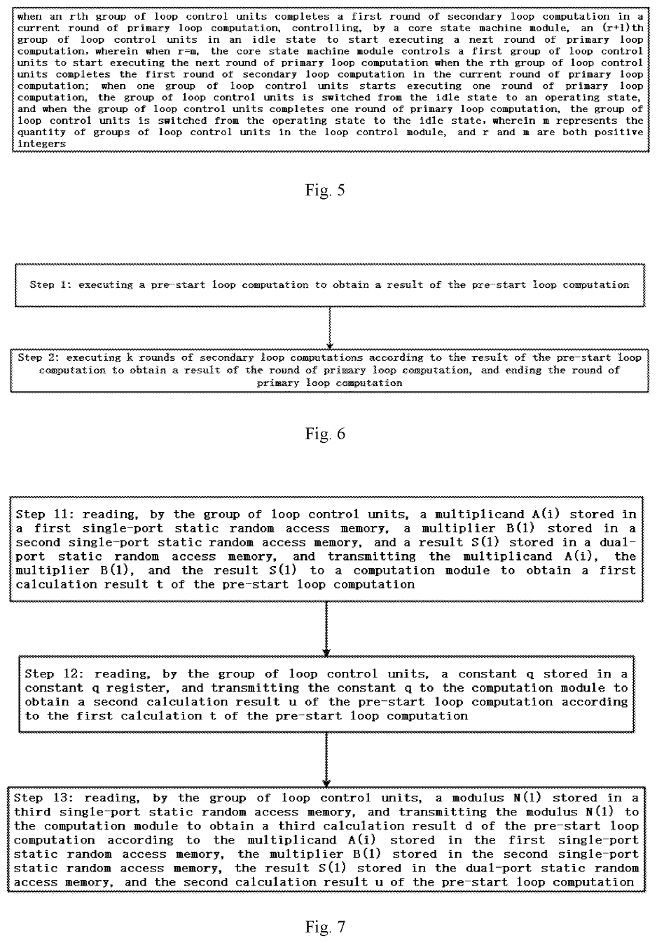

Specifically, as shown in FIG. 5, the core state machine module controls a first group of loop control units to start executing the first round of primary loop computation. When the first group of loop control units completes the first round of secondary loop computation in the first round of primary loop computation, the core state machine module controls a second group of loop control units to start executing a second round of primary loop computation; when the second group of loop control units completes the first round of secondary loop computation in the second round of primary loop computation, the core state machine module controls a third group of loop control units to start executing the third round of primary loop computation; . . . ; and when an (m−1)^{th} group of loop control units completes the first round of secondary loop computation in an (m−1)^{th} round of primary loop computation, the core state machine controls an m^{th} group of loop control units to start executing an m^{th} round of primary loop computation, wherein m represents the quantity of groups of loop control units in the loop control module, and r and m are both positive integers.

In an optional embodiment of the present disclosure, the executing, as shown in FIG. 6, by one group of loop control units, one round of primary loop computation specifically includes:
Step 1: executing a pre-start loop computation to obtain a result of the pre-start loop computation; and
Step 2: executing k rounds of secondary loop computations according to the result of the pre-start loop computation.

The result of the pre-start loop computation is the obtained third calculation result d. In this embodiment of the present disclosure, each round of first primary loop computation includes the pre-start loop computation and k rounds of second loop computations, and the execution of the k rounds of secondary loop computations is based on the result of the pre-start loop computation, so that the k rounds of secondary loop computations are nested within each round of primary loop computation.

In an optional embodiment of the present disclosure, as shown in FIG. 7, Step 1 of executing the pre-start loop computation to obtain the result of the pre-start loop computation specifically includes: Step 11: reading, by the group of loop control units, a multiplicand A(i) stored in a first single-port static random access memory, a multiplier B(1) stored in a second single-port static random access memory, and a result S(1) stored in a dual-port static random access memory, and transmitting the multiplicand A(i), the multiplier B(1) and the result S(1) to a computation module to obtain a first calculation result t of the pre-start loop computation; Step 12: reading, by the group of loop control units, a constant q stored in a constant q register, and transmitting the constant q to the computation module to obtain a second calculation result u of the pre-start loop computation according to the first calculation t of the pre-start loop computation; and Step 13: reading by the group of loop control units, a modulus N(1) stored in a third single-port static random access memory, and transmitting the modulus N(1) to the computation module to obtain a third calculation result d of the pre-start loop computation according to the multiplicand A(i) stored in the first single-port static random access memory, the multiplier B(1) stored in the second single-port static random access memory, the result S(1) stored in the dual-port static random access memory, and the second calculation result u of the pre-start loop computation.

To be specific, in the multiplicand A(i), i indicates a round index of a current round of primary loop computation executed by the group of loop control units. The multiplicand A(i) refers to an i^{th} group of multiplicand A pre-stored in the first single-port static random access memory. The multiplier B(1) refers to a first group of multiplier B pre-stored in the second single-port static random access memory. The result S(1) refers to a result of the first round of secondary loop computation in the previous round of primary loop computation. Particularly, when a first round of primary loop computation is currently executed, the result S(1) is a first group of initial result S pre-stored in the dual-port static random access memory.

In an optional embodiment of the present disclosure, Step 11 specifically includes the following steps.

The group of loop control units initiates a read computation on the multiplicand A(i) toward the first single-port static random access memory of a storage module according to a round index i of the round of primary loop computation executed by the group of loop control units, and initiates a read computation on the multiplier B(1) toward the second single-port static random access memory of the storage module. The multiplicand A(i) refers to an i^{th} group of multiplicand A pre-stored in the first single-port static random access memory. The multiplier B(1) refers to a first group of multiplier B pre-stored in the second single-port static random access memory.

The group of loop control units caches the read multiplicand A(i) into the multiplicand A register, caches the read multiplier B(1) into the multiplier B register, and simultaneously initiates a read computation on the result S(1) toward the dual-port static random access memory. The result S(1) refers to a result of the first round of secondary loop computation in the previous round of primary loop computation. Particularly, when the first round of primary loop computation is currently executed, the result S(1) is the first group of initial result S pre-stored in the dual-port static random access memory.

The group of loop control units caches the read result S(1) into an intermediate result S register, simultaneously transmits the multiplicand A(i) cached in the multiplicand A register to a first multiplier via a first input end, and transmits the multiplier B(1) cached in the multiplier B register to the first multiplier via a second input end, to allow the first multiplier to perform a multiplication computation on the multiplicand A(i) and the multiplier B(1).

The first multiplier transmits a product of the multiplicand A(i) and the multiplier B(1) to an adder, the group of loop control units transmits the result S(1) cached in the intermediate result S register to the adder via a fifth input end to allow the adder to perform an addition computation on the product of the multiplicand A(i) and the multiplier B(1) and the result S(1) and output a result of the addition computation as the first calculation result t to a corresponding group of loop control units, and the group of loop control units caches the first calculation result t into a first calculation result t register, where i is a positive integer less than or equal to k+1. In this embodiment of the present disclosure, the first calculation result of the pre-start loop computation in the high-radix Montgomery modular multiplication algorithm is calculated in two steps, i.e., the product of the multiplicand A(i) and the multiplier B(1) is calculated in a first step, and then a sum of the product of the multiplicand A(i) and the multiplier B(1) and the result S(1) is calculated in a second step, so as to obtain the first calculation result t.

In an optional embodiment of the present disclosure, Step 12 specifically includes: transmitting, by the group of loop control units, the first calculation result t cached in the first calculation result t register to the first multiplier via the first input end, reading, by the group of loop control units, the constant q from the constant q register, and transmitting the constant q to the first multiplier via the second input end, to allow the first multiplier to perform a multiplication computation on the first calculation result t and the constant q, and transmit a result of the multiplication computation on the first calculation result t and the constant q as the second calculation result u to the corresponding group of loop control units.

In an optional embodiment of the present disclosure, Step 13 specifically includes the following steps.

The group of loop control units caches the second calculation result u into a second calculation result u register, initiates a read computation on the modulus N(1) toward the third single-port static random access memory of the storage module, and caches the read modulus N(1) into a modulus N register. The modulus N(1) refers to a first group of modulus N pre-stored in the third single-port static random access memory.

The group of loop control units transmits the multiplicand A(i) cached in the multiplicand A register to the first multiplier via the first input end, transmits the multiplier B(1) cached in the multiplier B register to the first multiplier via the second input end to allow the first multiplier to perform the multiplication computation on the multiplicand A(i) and the multiplier B(1), transmits the second calculation result u cached in the second calculation result u register to a second multiplier via a third input end, and transmits the modulus N(1) cached in the modulus N register to the second multiplier via a fourth input end, to allow the second multiplier to perform a multiplication computation on the second calculation result u and the modulus N(1).

The group of loop control units transmits the result S(1) cached in the intermediate result S register to the adder via the fifth input end, the first multiplier transmits a product of the multiplicand A(i) and the multiplier B(1) to the adder via a seventh input end, and the second multiplier transmits a product of the modulus N(1) and the second calculation result u to the adder via an eighth input end, to allow the adder to perform an addition computation on the result S(1), the product of the multiplicand A(i) and the multiplier B(1), and the product of the modulus N(1) and the second calculation result u, and transmit a result of the addition computation as the third calculation result d to the corresponding group of loop control units. The group of loop control units caches the third calculation result d into a third calculation result d register, and obtains the third calculation result d as the result of the pre-start loop computation.

In an optional embodiment of the present disclosure, Step 2 of executing k rounds of secondary loop computations according to the result of the pre-start loop computation specifically includes the following steps.

The group of loop control units initiates, according to a round index j of the round of secondary loop computation executed by the group of loop control units, a read computation on a multiplier B(j+1) toward the second single-port static random access memory of the storage module, and a read computation on a modulus N(j+1) toward the third single-port static random access memory of the storage module, where j is a positive integer less than or equal to k. A value of j+1 is determined based on the round index j of the round of secondary loop computation executed by the group of loop control units. The multiplier B(j+1) refers to a (j+1)^{th} group of multiplier B pre-stored in the second single-port static random access memory. The modulus N(j+1) refers to a (j+1)^{th} group of modulus N pre-stored in the third single-port static random access memory.

The group of loop control units caches the read multiplier B(j+1) into the multiplier B register, caches the read modulus N(j+1) into the modulus N register, and initiates a read computation on a result S(j+1) toward the dual-port static random access memory. The result S(j+1) refers to a (j+1)^{th} group of result S pre-stored in the dual-port static random access memory. To be specific, when the group of loop control units executes the first round of primary loop computation, the result S(j+1) refers to the (j+1)^{th} group of initial result S pre-stored in the dual-port static random access memory. When the group of loop control units does not execute the first round of primary loop computation, the result S(j+1) refers to the (j+1)^{th} group of result S in k groups of results S stored in the dual-port static random access memory based on the result of the secondary loop computation in the previous round of primary loop computation.

The group of loop control units caches the read result S(j+1) into the intermediate result S register, transmits the multiplicand A(i) cached in the multiplicand A register to the first multiplier via the first input end, transmits the multiplier B(j+1) cached in the multiplier B register to the first multiplier via the second input end to allow the first multiplier to perform a multiplication computation on the multiplicand A(i) and the multiplier B(j+1), transmits the second calculation result u cached in the second calculation result u register to the second multiplier via the third input end, and transmits the modulus N(j+1) cached in the modulus N register to the second multiplier via the fourth input end, to allow the second multiplier to perform a multiplication computation on the second calculation result u and the modulus N(j+1), i.e., to obtain a product of the second calculation result u and the modulus N(j+1).

The group of loop control units transmits the result S(j+1) cached in the intermediate result S register to the adder via the fifth input end, and transmits the third calculation result d cached in the third calculation result d register to the adder via a sixth input end. The first multiplier transmits a product of the multiplicand A(i) and the multiplier B(j+1) to the adder via the seventh input end, and the second multiplier transmits a product of the modulus N(j+1) and the second calculation result u to the adder via the eighth input end, to allow the adder to perform an addition computation on the result S(1), the product of the multiplicand A(i) and the multiplier B(j+1), the product of the modulus N(j+1) and the second calculation result u, and the result of the pre-start loop computation, i.e., the third calculation result d, and cache a result of the addition computation as a result S(j) in the dual-port static random access memory for reading in a next round of primary loop computation, thereby to complete a current round of secondary loop computation.

Whether the round index of the round of secondary loop computation is equal to k is determined; if yes, Step 2 is ended; and if not, the round index of the round of secondary loop computation is incremented by 1, and the next round of secondary loop computation is executed. In this embodiment of the present disclosure, the loop controller determines whether the round index j of the round of secondary loop computation is equal to k, so as to control the ending of the round of secondary loop computation according to the round index of the round of secondary loop computation, and control the group of loop control units to maintain the current round of secondary loop computation when the round index j of the round of secondary loop computation is less than k.

In an optional embodiment of the present disclosure, Step 2 of executing k rounds of secondary loop computations according to the result of the pre-start loop computation further includes: when the round index j of the round of secondary loop computation is equal to k, transmitting, by the group of loop control units, the result of the addition computation as a result of the current round of primary loop computation to the result S register of the storage module for caching.

In an optional embodiment of the present disclosure, each group of loop control units has an upper limit on the quantity of rounds of primary loop computations capable of being completed. The quantity of rounds of primary loop computations capable of being completed by the first group of loop control units is 1+k/m, and the quantity of rounds of primary loop computations capable of being completed by the remaining groups of loop control units is k/m, where k/m is a positive integer. For example, in some embodiments of the present disclosure, the loop control module is configured with 4 groups of loop control units, i.e., m=4, and a radix- 32 Montgomery modular multiplication algorithm is achieved based on the 4 groups of loop control units, i.e., k=32. In the loop control module, a first group of loop control units is used to implement 9 rounds of primary loop computations, and second to fourth groups of loop control units are each used to implement 8 rounds of primary loop computations.

In an optional embodiment of the present disclosure, in order to ensure that, when the plurality of groups of loop control units operates in parallel, the reading, writing and invoking of the storage module and the computation module do not interfere with each other, the timing of multiplexing, by the m groups of loop control units in the loop control module, the first multiplier, the second multiplier and the adder in the computation module in a time-division manner is limited, the timing of reading the data from the first single-port static random access memory, the second single-port static random access memory, the third single-port static random access memory and the dual-port static random access memory as well as the constant q in the storage module in a time-division manner is limited, and the timing of writing data into the result S register in the storage module is limited. In this way, it is able to ensure that, in each clock cycle, only one loop control module performs a read computation on the first single-port static random access memory/the second single-port static random access memory/the third single-port static random access memory, and in each clock cycle, only one loop control module performs a read computation and a write computation on the dual-port static random access memory. A specific limiting logic may include, but not limited to, dividing the timing into groups each including 4 time units. In each group of timing, a read computation on the dual-port static random access memory is allowed to be performed within a first time unit, the multipliers are allowed to be invoked within a second time unit, the adder is allowed to be invoked within a third time unit, and read computations on the first single-port static random access memory, the second single-port static random access memory and the third single-port static random access memory and a write computation on the dual-port static random access memory are allowed to be performed within a fourth time unit. In this embodiment of the present disclosure, the group of loop control units is controlled to, in a time-division manner, read and invoke data from the memories and registers, transmit the data and perform the computations, so as to perform the read computation and the write computation on the storage module in a time-division manner, and multiplex the computation module in a time-division manner, thereby to improve the multiplexing efficiency of the storage module and the computation module when the plurality of groups of loop control units operate in parallel.

It should be appreciated that, all of, or parts of, the steps in the method embodiments may be implemented through hardware associated with programs or instructions. The programs may be stored in a computer-readable storage medium (any medium for storing a program code, such as Read Only Memory (ROM), Random Access Memory (RAM), magnetic disk or optical disk), and executed so as to perform the above-mentioned steps.

It should be appreciated that, each of the loop control module, the computation module and the storage module mentioned hereinabove includes, but not limited to, a digital circuit module described by a designer using the hardware description language Verilog HDL, or a digital circuit module drawn or compiled by the designer using software with a circuit drawing or compiling function. Furthermore, the functional units in the embodiments of the present disclosure may be integrated into a processing module, or the functional units may exist independently, or two or more functional units may be combined together.

Finally, it should be appreciated that, the above embodiments are for illustrative purposes only, but shall not be construed as limiting the present disclosure. Although the detailed description has been given hereinabove with reference to the embodiments, a person of ordinary skill in the art may make modifications or equivalent substitutions without departing from the scope of the present disclosure.

1. A high-radix Montgomery modular multiplication circuit, comprising:
a loop control module, comprising m groups of loop control units, and configured to execute loop computations in parallel to complete k+1 rounds of loop computations, cache intermediate data during the loop computations, read data for the loop computations from a storage module, and transmit corresponding data to a computation module according to loop computation steps;
a core state machine module, configured to control starting and ending of each round of primary loop computation in the k+1 rounds of loop computations executed by the m groups of loop control units in the loop control module;
the computation module, configured to receive data transmitted by the loop control module and perform a multiplication computation and an addition computation based on the received data; and
the storage module, configured to store the data for the loop computations for reading and invoking by the loop control module;
wherein the k+1 rounds of loop computations comprise in total k+1 rounds of primary loop computations, each round of primary loop computation in the k+1 rounds of primary loop computations comprises a pre-start loop computation and k rounds of secondary loop computations, and at most m rounds of loop computations are executed by the loop control module in parallel, wherein k and m are positive integers, and k is an integral multiple of m.

2. The high-radix Montgomery modular multiplication circuit according to claim 1, wherein the storage module comprises three single-port static random access memories, one dual-port static random access memory, and two registers;
the three single-port static random access memories comprise a first single-port static random access memory configured to store k+1 groups of multiplicands A, a second single-port static random access memory configured to store k+1 groups of multipliers B, and a third single-port static random access memory configured to store k+1 groups of moduli N;
the dual-port static random access memory is configured to store k+1 groups of initial results S and store a result of each round of secondary loop computation, and the k+1 groups of initial results S are used for a first round of loop computation in the k+1 rounds of loop computations; and
the two registers comprise a constant q register configured to store one group of constants q, and a result S register configured to store a result of each round of primary loop computation in the k+1 rounds of primary loop computations.

3. The high-radix Montgomery modular multiplication circuit according to claim 1, wherein the computation module comprises a first multiplier, a second multiplier, and an adder;
the first multiplier comprises a first input end, a second input end, and a first output end;
the second multiplier comprises a third input end, a fourth input end, and a second output end;
the adder comprises a fifth input end, a sixth input end, a seventh input end, an eighth input end, and a third output end;
the first input end, the second input end, the third input end, the fourth input end, the fifth input end, and the sixth input end serve as input ports of the computation module for receiving the data transmitted by the loop control module;
the first output end of the first multiplier is coupled to the seventh input end of the adder, and configured to transmit data obtained by the first multiplier through multiplication to the adder for addition;
the second output end of the second multiplier is coupled to the eighth input end of the adder, and configured to transmit data obtained by the second multiplier through multiplication to the adder for addition; and
the third output end of the adder serves as an output port of the computation module for outputting data obtained through addition.

4. The high-radix Montgomery modular multiplication circuit according to claim 3, wherein the computation module further comprises a first register, a second register, and a third register;
the first register is arranged between the first multiplier and the adder, the first output end is coupled to an input end of the first register, and an output end of the first register is coupled to the seventh input end of the adder;
the second register is arranged between the second multiplier and the adder, the second output end is coupled to an input end of the second register, and an output end of the second register is coupled to the eighth input end of the adder; and
an input end of the third register is coupled to the third output end of the adder, and an output end of the third register serves as the output port of the computation module.

5. The high-radix Montgomery modular multiplication circuit according to claim 4, wherein the first register further comprises a fourth output end, and the fourth output end serves as the output port of the computation module for outputting the data obtained by the first multiplier through multiplication.

6. The high-radix Montgomery modular multiplication circuit according to claim 3, wherein each group of loop control units in the m groups of loop control units comprises a loop controller configured to, in response to a start control signal for each round of primary loop computation from the core state machine module, read data stored in the storage module, and perform the round of primary loop computation through multiplexing the first multiplier, the second multiplier, and the adder in the computation module in a time-division manner according to the data read from the storage module, and further configured to control starting and ending of each round of secondary loop computation.

7. The high-radix Montgomery modular multiplication circuit according to claim 6, wherein each group of loop control units further comprises an intermediate data cache module configured to cache data read from the storage module during the loop computations and computation intermediate data fed back by the computation module for reading and invoking by the group of loop control units; wherein the intermediate data cache module comprises:
a first calculation result t register, configured to cache a first calculation result t fed back by the computation module;
a second calculation result u register, configured to cache a second calculation result u fed back by the computation module;
a third calculation result d register, configured to cache a third calculation result d fed back by the computation module;
a multiplicand A register, configured to cache a multiplicand A read by the loop control module from a first single-port static random access memory of the storage module;
a multiplier B register, configured to cache a multiplier B read by the loop control module from a second single-port static random access memory of the storage module;
a modulus N register, configured to cache a modulus N read by the loop control module from a third single-port static random access memory of the storage module; and
an intermediate result S register, configured to cache a result S read by the loop control module from a dual-port static random access memory of the storage module.

8. The high-radix Montgomery modular multiplication circuit according to claim 7, wherein
the first input end of the first multiplier is coupled to the multiplicand A register in each group of loop control units, to receive the multiplicand A cached in the multiplicand A register and transmitted by the loop control module;
the first input end of the first multiplier is further coupled to the first calculation result t register in each group of loop control units, to receive the first calculation result t cached in the first calculation result t register and transmitted by the loop control module;
the second input end of the first multiplier is coupled to the multiplier B register in each group of loop control units, to receive the multiplier B cached in the multiplier B register and transmitted by the loop control module;
the third input end of the second multiplier is coupled to the second calculation result u register in each group of loop control units, to receive the second calculation result u cached in the second calculation result u register and transmitted by the loop control module;
the fourth input end of the second multiplier is coupled to the modulus N register in each group of loop control units, to receive the modulus N cached in the modulus N register and transmitted by the loop control module;
the fifth input end of the adder is coupled to the intermediate result S register in each group of loop control units, to receive the result S cached in the intermediate result S register and transmitted by the loop control module; and
the sixth input end of the adder is coupled to the third calculation result d register in each group of loop control units, to receive the third calculation result d cached in the third calculation result d register and transmitted by the loop control module.

9. A parallel computation method for a high-radix Montgomery modular multiplication circuit, comprising:
when an r^{th} group of loop control units completes a first round of secondary loop computation in a current round of primary loop computation, controlling, by a core state machine module, an (r+1)^{th} group of loop control units in an idle state to start executing a next round of primary loop computation;
wherein when r=m, the core state machine module controls a first group of loop control units to start executing the next round of primary loop computation when the r^{th} group of loop control units completes the first round of secondary loop computation in the current round of primary loop computation; when one group of loop control units starts executing one round of primary loop computation, the group of loop control units is switched from the idle state to an operating state, and when the group of loop control units completes one round of primary loop computation, the group of loop control units is switched from the operating state to the idle state;
wherein m represents a quantity of groups of loop control units in a loop control module, and r and m are both positive integers.

10. The parallel computation method according to claim 9, wherein the executing, by one group of loop control units, one round of primary loop computation comprises:
Step 1: executing a pre-start loop computation to obtain a result of the pre-start loop computation; and
Step 2: executing k rounds of secondary loop computations according to the result of the pre-start loop computation to obtain a result of the round of primary loop computation, and ending the round of primary loop computation.

11. The parallel computation method according to claim 10, wherein Step 1 of executing the pre-start loop computation to obtain the result of the pre-start loop computation comprises:
Step 11: reading, by the group of loop control units, a multiplicand A(i) stored in a first single-port static random access memory, a multiplier B(1) stored in a second single-port static random access memory, and a result S(1) stored in a dual-port static random access memory, and transmitting the multiplicand A(i), the multiplier B(1), and the result S(1) to a computation module to obtain a first calculation result t of the pre-start loop computation;
Step 12: reading, by the group of loop control units, a constant q stored in a constant q register, and transmitting the constant q to the computation module to obtain a second calculation result u of the pre-start loop computation according to the first calculation t of the pre-start loop computation; and
Step 13: reading, by the group of loop control units, a modulus N(1) stored in a third single-port static random access memory, and transmitting the modulus N(1) to the computation module to obtain a third calculation result d of the pre-start loop computation according to the multiplicand A(i) stored in the first single-port static random access memory, the multiplier B(1) stored in the second single-port static random access memory, the result S(1) stored in the dual-port static random access memory, and the second calculation result u of the pre-start loop computation.

12. The parallel computation method according to claim 10, wherein Step 11 comprises:
initiating, by the group of loop control units, a read computation on the multiplicand A(i) toward the first single-port static random access memory of a storage module according to a round index of the round of primary loop computation executed by the group of loop control units, and initiating a read computation on the multiplier B(1) toward the second single-port static random access memory of the storage module;
caching, by the group of loop control units, the read multiplicand A(i) into the multiplicand A register, caching the read multiplier B(1) into the multiplier B register, and simultaneously initiating, by the group of loop control units, a read computation on the result S(1) toward the dual-port static random access memory;
caching, by the group of loop control units, the read result S(1) into an intermediate result S register, simultaneously transmitting, by the group of loop control units, the multiplicand A(i) cached in the multiplicand A register to a first multiplier via a first input end, and transmitting the multiplier B(1) cached in the multiplier B register to the first multiplier via a second input end, to allow the first multiplier to perform a multiplication computation on the multiplicand A(i) and the multiplier B(1); and
transmitting, by the first multiplier, a product of the multiplicand A(i) and the multiplier B(1) to an adder, transmitting, by the group of loop control units, the result S(1) cached in the intermediate result S register to the adder via a fifth input end to allow the adder to perform an addition computation on the product of the multiplicand A(i) and the multiplier B(1) and the result S(1) and output a result of the addition computation as the first calculation result t to a corresponding group of loop control units, and caching, by the group of loop control units, the first calculation result t of the pre-start loop computation into a first calculation result t register, wherein i is a positive integer less than or equal to k+1.

13. The parallel computation method according to claim 12, wherein Step 12 comprises:
transmitting, by the group of loop control units, the first calculation result t cached in the first calculation result t register to the first multiplier via the first input end, reading, by the group of loop control units, the constant q from the constant q register, and transmitting the constant q to the first multiplier via the second input end, to allow the first multiplier to perform a multiplication computation on the first calculation result t and the constant q, and transmit a result of the multiplication computation on the first calculation result t and the constant q as the second calculation result u of the pre-start loop computation to the corresponding group of loop control units.

14. The parallel computation method according to claim 13, wherein Step 13 comprises:
caching, by the group of loop control units, the second calculation result u into a second calculation result u register, and simultaneously initiating, by the group of loop control units, a read computation on the modulus N(1) toward the third single-port static random access memory of the storage module;
caching, by the group of loop control units, the read modulus N(1) into a modulus N register;
transmitting, by the group of loop control units, the multiplicand A(i) cached in the multiplicand A register to the first multiplier via the first input end, transmitting the multiplier B(1) cached in the multiplier B register to the first multiplier via the second input end to allow the first multiplier to perform the multiplication computation on the multiplicand A(i) and the multiplier B(1), transmitting, by the group of loop control units, the second calculation result u cached in the second calculation result u register to a second multiplier via a third input end, and transmitting, by the group of loop control units, the modulus N(1) cached in the modulus N register to the second multiplier via a fourth input end, to allow the second multiplier to perform a multiplication computation on the second calculation result u and the modulus N(1);
transmitting, by the group of loop control units, the result S(1) cached in the intermediate result S register to the adder via the fifth input end, transmitting, by the first multiplier, a product of the multiplicand A(i) and the multiplier B(1) to the adder via a seventh input end, and transmitting, by the second multiplier, a product of the modulus N(1) and the second calculation result u to the adder via an eighth input end, to allow the adder to perform an addition computation on the result S(1), the product of the multiplicand A(i) and the multiplier B(1), and the product of the modulus N(1) and the second calculation result u, and transmit a result of the addition computation as the third calculation result d to the corresponding group of loop control units; and
caching, by the group of loop control units, the third calculation result d into a third calculation result d register, and obtaining the third calculation result d as the result of the pre-start loop computation.

15. The parallel computation method according to claim 14, wherein Step 2 of executing k rounds of secondary loop computations according to the result of the pre-start loop computation comprises:
initiating, by the group of loop control units, according to a round index of the round of secondary loop computation executed by the group of loop control units, a read computation on a multiplier B(j+1) toward the second single-port static random access memory of the storage module, and a read computation on a modulus N(j+1) toward the third single-port static random access memory of the storage module;
caching, by the group of loop control units, the read multiplier B(j+1) into the multiplier B register, caching the read modulus N(j+1) into the modulus N register, and initiating a read computation on a result S(j+1) toward the dual-port static random access memory;
caching, by the group of loop control units, the read result S(j+1) into the intermediate result S register, transmitting, by the group of loop control units, the multiplicand A(i) cached in the multiplicand A register to the first multiplier via the first input end, transmitting the multiplier B(j+1) cached in the multiplier B register to the first multiplier via the second input end to allow the first multiplier to perform a multiplication computation on the multiplicand A(i) and the multiplier B(j+1), transmitting, by the group of loop control units, the second calculation result u cached in the second calculation result u register to the second multiplier via the third input end, and transmitting the modulus N(j+1) cached in the modulus N register to the second multiplier via the fourth input end, to allow the second multiplier to perform a multiplication computation on the second calculation result u and the modulus N(j+1);
transmitting, by the group of loop control units, the result S(j+1) cached in the intermediate result S register to the adder via the fifth input end, transmitting, by the group of loop control units, the third calculation result d cached in the third calculation result d register to the adder via a sixth input end, transmitting, by the first multiplier, a product of the multiplicand A(i) and the multiplier B(j+1) to the adder via the seventh input end, and transmitting, by the second multiplier, a product of the modulus N(j+1) and the second calculation result u to the adder via the eighth input end, to allow the adder to perform an addition computation on the result S(1), the product of the multiplicand A(i) and the multiplier B(j+1), the product of the modulus N(j+1) and the second calculation result u, and the result of the pre-start loop computation, and cache a result of the addition computation as a result S(j) in the dual-port static random access memory for reading in a next round of primary loop computation, thereby to complete a current round of secondary loop computation; and
determining whether the round index of the round of secondary loop computation is equal to k; if yes, ending step 2; and if not, incrementing the round index of the round of secondary loop computation by 1, and proceeding to the next round of secondary loop computation,
wherein j is a positive integer less than or equal to k.

16. The parallel computation method according to claim 14, wherein Step 2 of executing k rounds of secondary loop computations according to the result of the pre-start loop computation further comprises:
when the round index of the round of secondary loop computation is equal to k, transmitting, by the group of loop control units, the result of the addition computation as a result of the current round of primary loop computation to the result S register of the storage module for caching.
